(19) United States
(12) Patent Application Publication
(10) Pub. No.: US 2016/0291335 A1
(43) Pub. Date: Oct. 6, 2016

(54) LIQUID CRYSTAL LENS LIGHT SPLITTING DEVICE AND MANUFACTURING METHOD THEREOF, AND STEREOSCOPIC DISPLAY DEVICE

(71) Applicant: BOE TECHNOLOGY GROUP CO., LTD., Beijing (CN)

(72) Inventors: Kun WU, Beijing (CN); Chuanxiang XU, Beijing (CN)

(73) Assignee: BOE TECHNOLOGY GROUP CO., LTD., Beijing (CN)

(21) Appl. No.: 14/771,614

(22) PCT Filed: Jan. 4, 2015
(86) PCT No.: PCT/CN2015/070018

§ 371 Date: Aug. 31, 2015

(30) Foreign Application Priority Data
Sep. 5, 2014 (CN) 201410450047.8

(51) Int. Cl. G02B 27/22; G02F 1/29

(52) U.S. Cl. CPC G02B 27/2214; G02F 1/29; G02F 2201/44

(57) ABSTRACT

A liquid crystal lens light splitting device (100) and a manufacturing method thereof, and a stereoscopic display device are disclosed. The liquid crystal lens light splitting device (100) is configured to be disposed on a display panel (200) and includes: a first substrate (110), and a second substrate (120) disposed on a light outgoing side of the display panel (200), wherein liquid crystal (150) is filled between the first substrate (110) and the second substrate (120), and a support (130) is provided between the first substrate (110) and the second substrate (120), and wherein the support (130) is opposite to a non-light-outgoing area (201) on the display panel in a light outgoing direction of the display panel (200). The liquid crystal lens light splitting device (100) can mitigate or eliminate crosstalk phenomenon and be used for manufacturing a display device.

### TECHNICAL FIELD

Embodiments of the present invention relate to a liquid crystal lens light splitting device and a manufacturing method thereof, and a stereoscopic display device.

### BACKGROUND

With the rapid development of stereoscopic display technology, there are more and more demands for stereoscopic display apparatuses. Among numerous current technologies for three-dimensional stereoscopic display, naked eye stereoscopic display technology has received gratifying attention in three-dimensional stereoscopic display field as viewers need not to wear glasses.

At present, a fundamental mode for implementing naked eye stereoscopic display technology is disposing an optical grating in front of display panel to divide pixel units of the display panel into pixel units in odd numbered columns and pixel units in even numbered columns in the horizontal direction, thereby providing two different images for the left and the right eyes of the viewer respectively. Parallax effect of images for the left and the right eyes of the viewer forms a depth of field, and in turn generates a stereoscopic display effect. Optical gratings include two types, namely blocking gratings and light splitting gratings. Blocking gratings are in turn classified into black and white parallax barrier gratings and liquid crystal slit gratings. Light splitting gratings are classified into column physical lens and liquid crystal lens.

Liquid crystal lens stereoscopic display technology requires a large thickness of liquid crystal layer, which is generally greater than or equal to 10 nm, for guaranteeing optical signals to have good phase delay amount after passing through liquid crystal lens, thereby generating two different images. It is possible to use spherical ball spacers (BS) such as silicon balls with large diameter as supports for keeping the liquid crystal layer thickness. Ball spacers are distributed between substrates for liquid crystal lens in dispersing manner with their positions and density out of accurate control.

In a liquid crystal lens, if one or more supports are located in the display areas in pixel units in the display panel, liquid crystal can not be filled at positions occupied by supports and the supports would impact alignment of liquid crystal molecules in liquid crystal lens corresponding to the display areas. Due to the pressing of supports, nearby liquid crystal molecules can not be aligned in the predetermined direction of forming lens, thereby causing generation of scattered stray rays and resulting in crosstalk phenomenon.

### SUMMARY

Embodiments of the present invention provide a liquid crystal lens light splitting device and a manufacturing method thereof, and a stereoscopic display device for mitigating or eliminating crosstalk phenomenon.

At least one embodiment of the present invention provides a liquid crystal lens light splitting device configured to be disposed on a display panel, including: a first substrate and a second substrate that is configured to be disposed on a light outgoing side of the display panel; liquid crystal is filled between the first substrate and the second substrate, and supports provided between the first substrate and the second substrate; and the supports are opposite to non-light-outgoing areas on the display panel in the light outgoing direction of the display panel.

For example, the liquid crystal can form at least two liquid crystal lenses, and the supports can be located at a border of adjacent liquid crystal lenses of the at least two liquid crystal lenses.

For example, the support can be uniformly disposed between the first substrate and the second substrate.

For example, the support can be a photoresist spacer.

For example, the support can be a post support and the cross section of the support in the light outgoing direction of the display panel can be a circle or a polygon.

For example, the support can include a first part and a second part; one end of the first part of the support contacts the first substrate, another end of the first part of the support contacts one end of the second part of the support, and another end of the second part of the support contacts the second substrate.

For example, the display panel is a liquid crystal display panel, and the non-light-outgoing areas are black matrix areas.

An embodiment of the present invention further provides a stereoscopic display device comprising a display panel and a liquid crystal lens light splitting device configured to be disposed on a light outgoing side of the display panel, the liquid crystal lens light splitting device being any one of the above-mentioned liquid crystal lens light splitting devices.

An embodiment of the present invention further provides a manufacturing method of liquid crystal lens, comprising: providing a first substrate as well as a second substrate that is configured to be disposed on a light outgoing side of a display panel; forming a support on the first substrate and/or the second substrate; cell assembling the first substrate and the second substrate and filling liquid crystal therebetween; and the support being opposite to a non-light-outgoing area on the display panel in the light outgoing direction of the display panel.

For example, forming a support on the first substrate can comprise: forming a first part of the support on the first substrate by a patterning process; forming a second part of the support on the first part of the support by a patterning process; wherein the first part of the support and the second part of the support constitute the support.

For example, forming a support on the second substrate can comprise: forming a second part of the support on the second substrate by a patterning process; forming a first part of the support on the second part of the support by a patterning process; wherein the first part of the support and the second part of the support constitute the support.

For example, forming a support on the first substrate and the second substrate can comprise: forming a first part of the support on the first substrate by a patterning process; and forming a second part of the support on the second substrate by a patterning process; wherein the first part of the support and the second part of the support constitute the support.

For example, the support can be formed by one patterning process from a material having a viscosity higher than a predetermined viscosity value.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic structure view of a liquid crystal lens light splitting device according to an embodiment of the present invention;

FIG. 2 is a view illustrating the position of support according to an embodiment of the present invention;

FIG. 3 is a view illustrating the position of support according to another embodiment of the present invention;

FIG. 4 is a schematic structure view of a liquid crystal lens light splitting device according to another embodiment of the present invention;

FIG. 5 is a schematic structure view of a liquid crystal lens light splitting device according to yet another embodiment of the present invention;

FIG. 6 is a schematic structure view of a liquid crystal lens light splitting device according to yet another embodiment of the present invention;

FIG. 7 is a schematic structure view of a liquid crystal lens light splitting device according to another embodiment of the present invention;

FIG. 8 is a schematic structure view of a liquid crystal lens light splitting device according to yet another embodiment of the present invention;

FIG. 9 is a schematic structure view of a liquid crystal lens light splitting device according to yet another embodiment of the present invention; and

FIG. 10 is a schematic structure view of a liquid crystal lens light splitting device according to another embodiment of the present invention.

### REFERENCE NUMERALS

100-liquid crystal lens light splitting device; 110-first substrate; 120-second substrate; 130-support; 140-border between adjacent liquid crystal lenses; 1301-first part of support; 1302-second part of support; 140-border between liquid crystal lens; 150-liquid crystal; 200-display panel; 201-non-light-outgoing area; 111-first base substrate; 112-electrode lead; 113-first insulating layer; 114-first electrode; 115-second insulating layer; 116-first orientation layer; 121-second base substrate; 122-second electrode; 123-second orientation layer.

### DETAILED DESCRIPTION

The liquid crystal lens and manufacturing method thereof, and the display panel according to embodiments of the present invention will be described below in detail with reference to accompanying drawings. Obviously, the accompanying drawings in the following description just relate to some embodiments of the present invention and can not be construed as a limit to the present invention.

It should be noted that same reference numerals are used in the embodiments of the present invention to indicate same elements in the present description. In the following description, for purpose of easy interpretation, many specific details are set forth to make one or more embodiments comprehensively understood. However, it is obvious that the embodiments can also be implemented without these specific details.

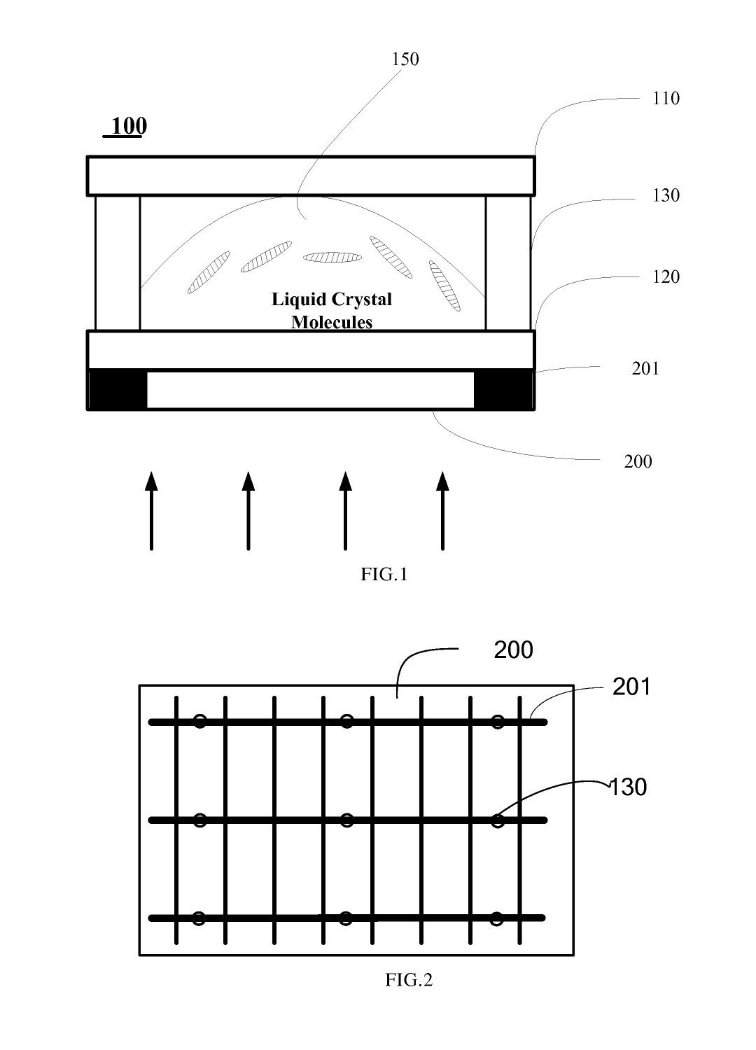

Referring to FIGS. 1 and 2, an embodiment of the present invention provides a liquid crystal lens light splitting device 100 configured to be disposed on a display panel 200, including: a first substrate 110 and a second substrate 120, in which the second substrate 120 is disposed on the light outgoing side of the display panel (in FIG. 1, the arrow under the second substrate 120 denotes the light direction), and accordingly the first substrate 110 is farther away from the light outgoing layer of the display panel; liquid crystal 150 is filled between the first substrate 110 and the second substrate 120, and a support 130 is provided between the first substrate 110 and the second substrate 120; and the support 130 is opposite to a non-light-outgoing area 201 on the display panel 200 in the light outgoing direction of the display panel 200.

For example, the above-mentioned non-light-outgoing area 201 can be a non-light-outgoing area between adjacent pixel units in a display panel in any display mode. For example, if the display panel is an organic light emitting diode (OLED) display panel, the non-light-outgoing area 201 can be an area between adjacent pixel units; and if the display panel is a liquid crystal display panel, the non-light-outgoing area 201 can be black matrix area. Furthermore, for example, the support 130 is a post support and the cross section of the support in the light outgoing direction of display panel (with reference to FIG. 1) is a circle or a polygon. It is appreciated that if the cross section of the support is a circle, the lateral side of the support can be a cylinder face or a truncated cone surface. A photoresist spacer can be used as the support. Base substrates for the first substrate 110 and the second substrate 120 can be glass substrates, plastic substrates or substrates of other materials. The second substrate 120 of the liquid crystal lens light splitting device is disposed on the light outgoing side of the display panel, that is, light emitted from the display panel enters the liquid crystal lens light splitting device 100 via the second substrate 120. In addition, the substrate on light outgoing side of display panel can share a base substrate with the above-mentioned second substrate 120. For example, if the display panel is a liquid crystal display panel, the color filter substrate of the display panel and the above-mentioned second substrate 120 can share a base substrate.

Liquid crystal 150 is filled between the first substrate 110 and the second substrate 120, which can form liquid crystal lenses under the control of electrodes on the first substrate 110 and the second substrate 120. The liquid crystal lenses are arranged in an array in the liquid crystal lens light splitting device 100 to split light entering the liquid crystal lens light splitting device 100 via the second substrate 120, thereby realizing 3D display.

In the liquid crystal lens light splitting device according to the above-mentioned embodiment, the support between the first substrate and second substrate are opposite to a non-light-outgoing area on the display panel in the light outgoing direction of the display panel, and will not impact the alignment sequence of liquid crystal molecules corresponding to light transmitting zones of the display panel between the first substrate and second substrate, thereby mitigating or eliminating crosstalk phenomenon. Furthermore, the support will not block light in the transmitting zone of the display panel passing through the liquid crystal lenses, which can further reduce or avoid influence on transmittance of display panel by the support.

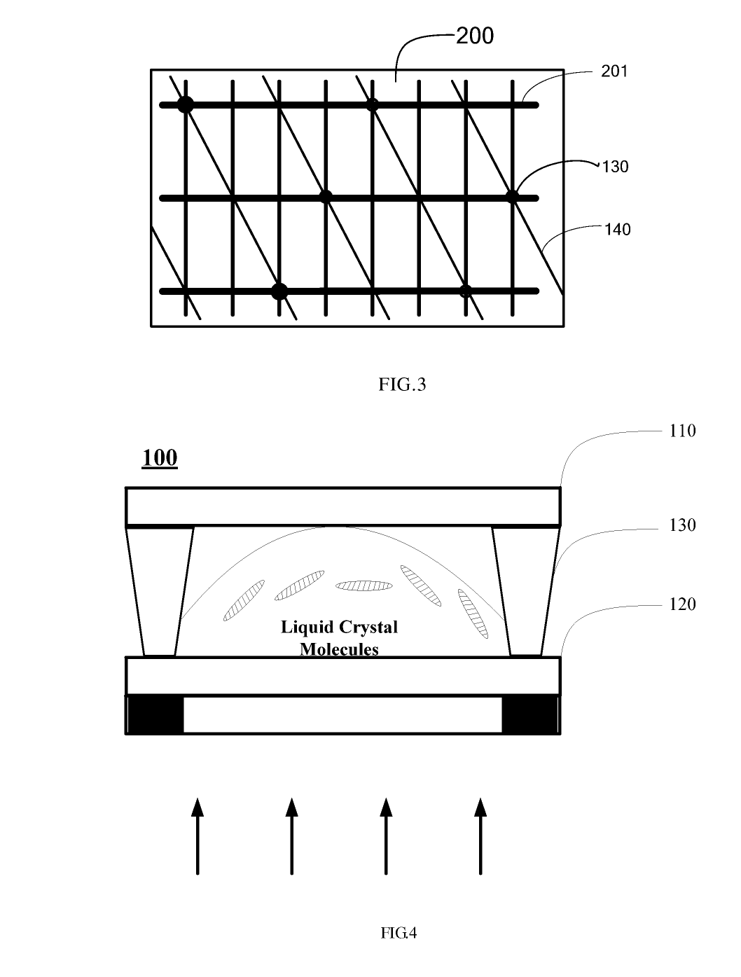

For example, referring to FIG. 3, the liquid crystal forms at least two liquid crystal lenses and a support is located in the border 140 between adjacent liquid crystal lenses. When the support is located in an area of liquid crystal lens formed by liquid crystal, since liquid crystal can not be filled at a position corresponding to the support in the liquid crystal lenses, and furthermore, the presence of support will impact rotation of liquid crystal molecules in the liquid crystal lenses, the support arranged at border between adjacent liquid crystal lenses avoids the generation of stray light, and in turn mitigates crosstalk among liquid crystal lenses.

For example, generally speaking, liquid crystal at border between adjacent liquid crystal lenses is affected by the orientation direction of the liquid crystal orientation layer, and deflected by the same angle in the initial state. However, after an electric field is applied, electric fields on two sides of the border between adjacent liquid crystal lenses have opposite directions. With this influence, liquid crystal at border between adjacent liquid crystal lenses would stagger and stray light would occur in turn. In the embodiment of the present invention, the support is disposed at border between adjacent liquid crystal lenses, liquid crystal at border between adjacent liquid crystal lenses is substituted by the support, thus eliminating stagger of liquid crystal at the position of support and in turn mitigating the generation of stray light.

For example, the support can be a post support with a cross section of a circle or polygon in the light outgoing direction of display panel. Referring to the figures, taking a cross section of circle as an example, the support is a circular cylinder or a truncated cone with side wall of cylinder side wall or truncated cone side wall. As compared to typical spherical supports, cylinder side wall or truncated cone side wall facilitate order arrangement of liquid crystal molecules, avoid the problem that liquid crystal molecules around spherical support can not be aligned in order in predetermined orientation direction due to their spherical walls, thereby effectively reducing light scattering and in turn mitigating the crosstalk phenomenon.

For example, the support 13 can be disposed uniformly between the first substrate and the second substrate. As compared to typical spherical supports, spherical supports are dispersed between the first substrate and the second substrate in a random manner, their positions and density can not be controlled accurately, thereby causing scattering of light, namely stray light. In embodiments of the invention, the support is formed between the first substrate and the second substrate through a manufacturing process. Therefore, they can be uniformly distributed between the first substrate and the second substrate regularly with the same density in the whole area of the light splitting device, thereby further avoiding generation of stray light and enhancing homogeneity of the light splitting device.

Implementations of embodiments of the present invention will be described in detail below with respect to the support being photoresist spacers (PS) as an example.

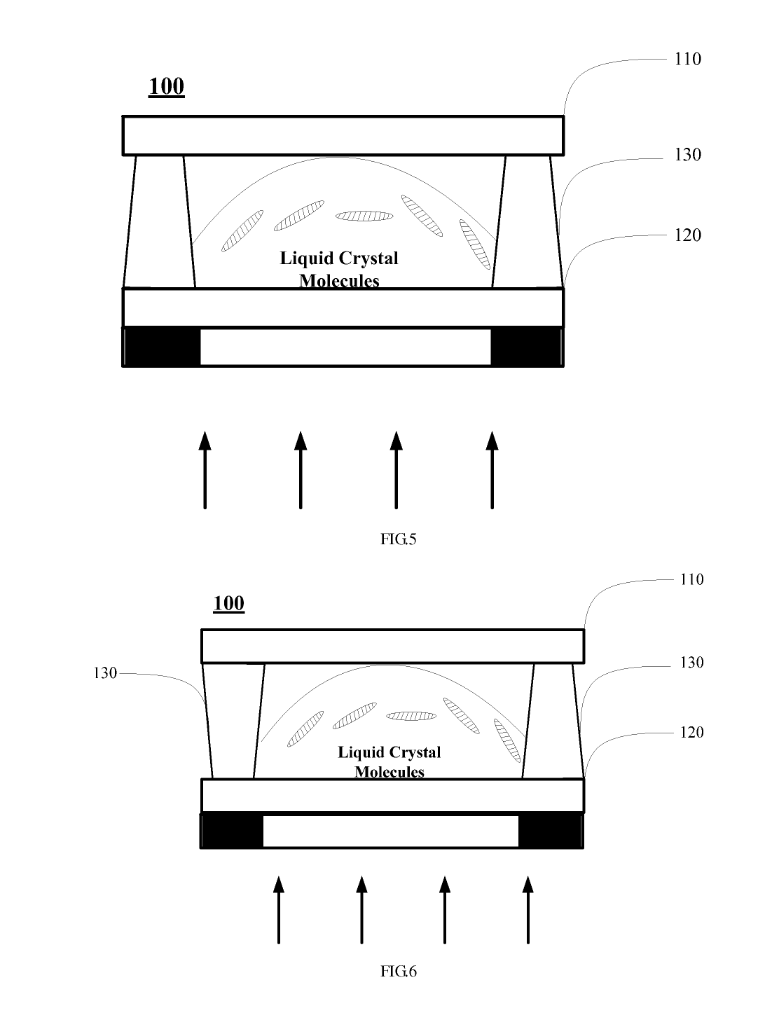

For example, referring to FIG. 4 or 5, the support can be formed by one patterning process. And then, one end of the support 130 contacts the first substrate 110, and the other end of the support 130 contacts the second substrate 120.

Photoresist spacers produced by conventional mass production processes typically have height in an order of 5 μm, while height of the support required by liquid crystal lenses are generally greater than or equal to 10 nm. In order to obtain the support 130 in corresponding embodiments of FIG. 4 or 5 with no common process step added, it is possible to form the support 130 by coating photoresist spacer material with viscosity higher than a predetermined value for one time through one patterning process. Here, photoresist spacer material with “a viscosity higher than a predetermined value” means that the viscosity is two or more times the viscosity of photoresist spacer material used in conventional mass production processes. It is to be noted that, one having ordinary skill in the art can definitely determine the predetermined value of viscosity according to common technical means and specific requirements on operating condition. FIG. 4 illustrates a support formed on the first substrate as an example. FIG. 5 illustrates a support formed on the second substrate as an example. What is illustrated in FIG. 6 can be considered as forming a support on both the first substrate and the second substrate at the same time in the liquid crystal lens light splitting device and forming the structure illustrated in FIG. 6 after cell assembling.

For example, in order to control the material cost, it is possible to form a support 130 by two patterning processes in the way that photoresist spacers are produced in conventional mass production processes. Referring to embodiments illustrated in FIGS. 7, 8 and 9, a support 130 includes a first part 1301 and a second part 1302; the first part 1301 of the support 130 has one end contacting the first substrate 110 and the other end contacting one end of the second part 1302 of the support 130, and the second part 1302 of the support 130 has the other end contacting the second substrate 120.

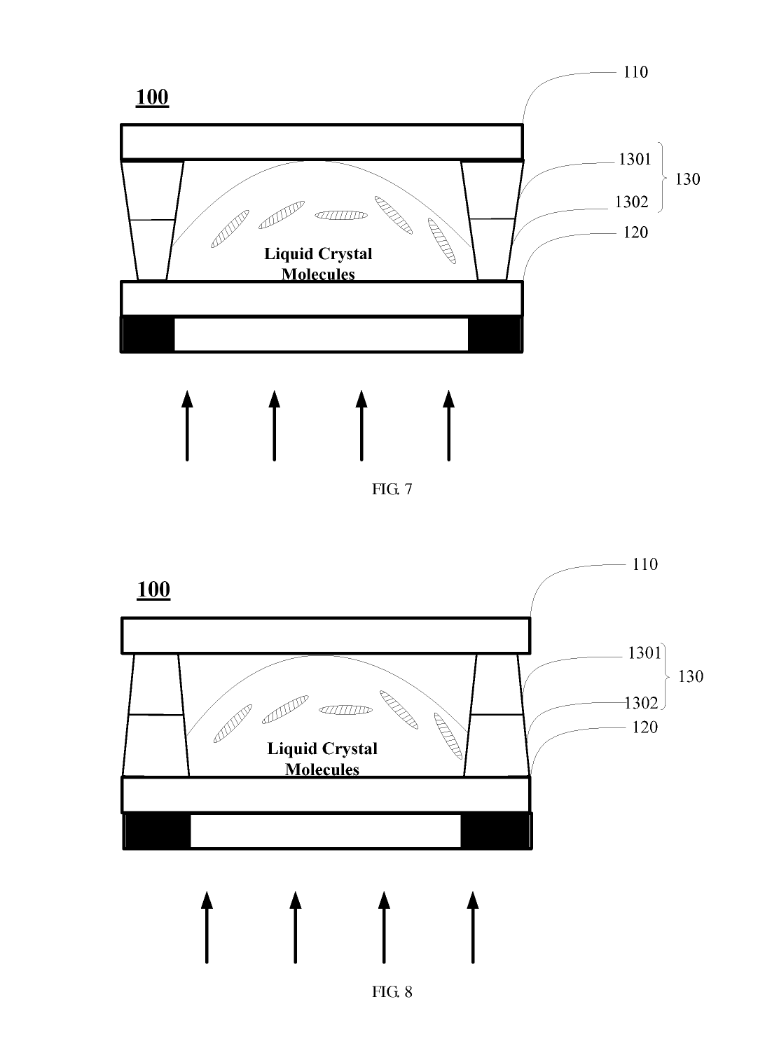

Referring to FIG. 7, the support 130 is disposed on the first substrate 110. After forming the first part 1301 of support 130 on the first substrate 110 through coating the photoresist spacer material for the first time, the first part 1301 of a support 130 is procured first, and then the second part 1302 of the support 130 is formed by coating photoresist spacer material for the second time. Referring to FIG. 8, the support 130 is configured to be disposed on the second substrate 120. After forming the second part 1302 of the support 130 through coating the photoresist spacer material for the first time, the second part 1302 of the support 130 is procured first, and then the first part 1301 of the support 130 is formed by coating photoresist spacer material for the second time. Referring to FIG. 9, the first part 1301 of the support 130 is disposed on the first substrate 110, and the second part 1302 of the support 130 is disposed on the second substrate 120. After cell assembling, the first part 1301 of the support 130 and the second part 1302 of the support 130 contact each other to maintain the cell thickness.

In the liquid crystal lens light splitting device according to the above-mentioned embodiment, the support between the first substrate and second substrate is opposite to a non-light-outgoing area on the display panel in the light outgoing direction of the display panel, and will not impact the alignment sequence of liquid crystal molecules corresponding to the light transmitting zone of the display panel between the first substrate and second substrate, thereby mitigating or eliminating crosstalk phenomenon. Furthermore, the support will not block light in the transmitting zone of the display panel to pass through the liquid crystal lenses, which can further mitigate or avoid influence on transmittance of display panel by the support. Furthermore, the support consists of the first part and the second part formed by two patterning processes respectively and can be manufactured completely with common manufacturing processes, which reduces the production complexity.

An embodiment of the present invention provides a manufacturing method of liquid crystal lens light splitting device which can include the following steps.

S801, providing the first substrate as well as the second substrate that is configured to be disposed on light outgoing side of the display panel.

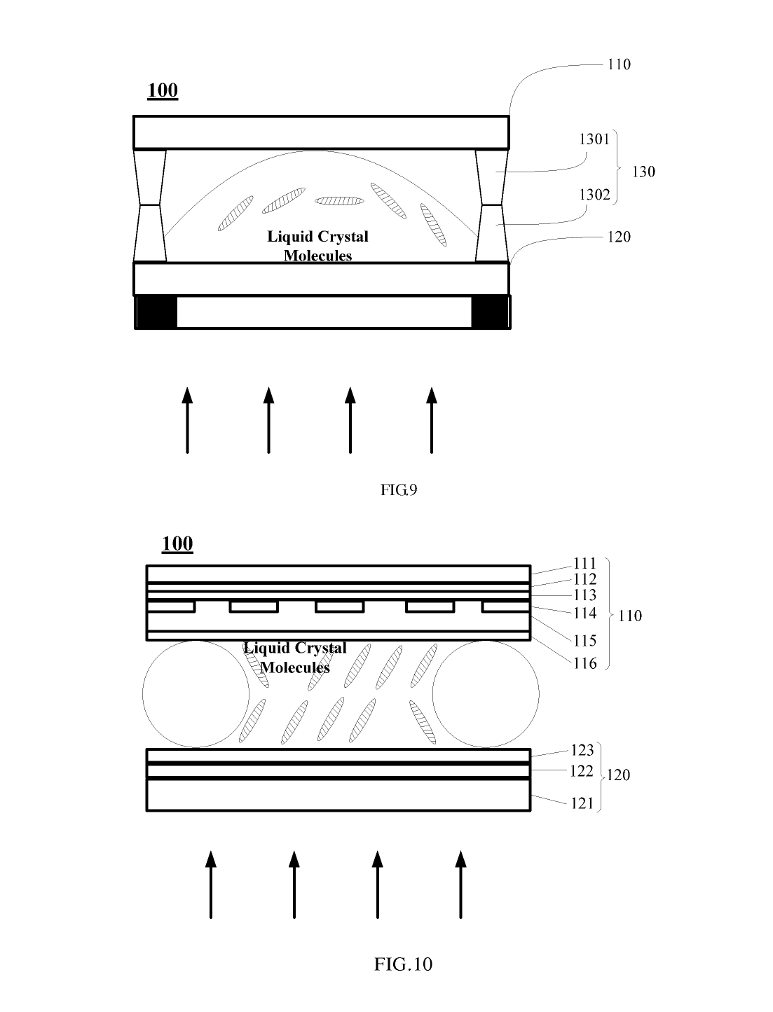

The first substrate and second substrate can be provided through common technologies. The first substrate and the second substrate can be provided as illustrated in FIG. 10, which is of course illustrative rather than limiting the present invention. As illustrated in FIG. 10, an implementation will be described as below.

S801, providing the first substrate 110 including the first base substrate 111, electrode leads 112, the first insulating layer 113, the first electrodes 114, the second insulating layer 115 and the first orientation layer 116; and providing the second substrate 120 including the second base substrate 121, the second electrodes 122 and the second orientation layer 123. In the figure, the first electrode 114 can be a comb-like electrode, and the second electrode 122 is a plate common electrode. Furthermore, the first base substrate 111 and the second base substrate 121 can be glass substrates, plastic substrates or substrates of other materials, and the manufacturing method for the substrates can be the same as common technologies, which will not be described any more here.

In S802, forming a support on the first substrate and/or the second substrate.

For example, the support is formed of a photoresist spacer material. The manufacturing method of the support can be a patterning process that generally includes steps of cleaning substrate, forming film, coating photoresist, exposing, developing, etching, and peeling photoresist off. A metal layer is typically formed with physical vapor deposition such as magnetron sputtering and patterned by wet etching, and a non-metal layer is typically formed with chemical vapor deposition and patterned by dry etching. The following steps can be included:

step 1, coating photoresist on the photoresist spacer material on substrate;

step 2, exposing the substrate with a mask having a transmitting zone and an opaque zone wherein the transmitting zone or opaque zone correspond to an area for forming a support;

step 3, developing the substrate to remove photoresist in the area corresponding to the non-support area; and

step 4, selecting an etching method according to the material of substrate to etch exposed photoresist spacer material on the substrate and finally forming the support.

For example, when height of the support is used to support the thickness of liquid crystal layer independently, the support is formed by one patterning process. The viscosity of support material is higher than a predetermined viscosity value. Generally speaking, height of the support required by liquid crystal lenses is generally greater than or equal to 10 μm, while photoresist spacers produced by conventional mass production process can generally have a height in an order of 5 μm. In order to obtain supports with no process steps of common technologies added, the support can be formed by coating photoresist spacer material with a viscosity higher than a predetermined value for one time and through one patterning process. Photoresist spacer material with “a viscosity higher than a predetermined value” means that the viscosity is two or more times the viscosity of photoresist spacer material used in conventional mass production processes.

S803, cell-assembling the first substrate and the second substrate and filling liquid crystal.

The support is opposite to a non-light-outgoing area on the display panel in the light outgoing direction of the display panel.

In the liquid crystal lens light splitting device manufactured by the method according to the embodiment of the present invention, the support between the first substrate and second substrate is opposite to an non-light-outgoing area on the display panel in the light outgoing direction of the display panel, and will not impact the orientation sequence of liquid crystal molecules corresponding to the light transmitting zone of the display panel between the first substrate and second substrate, thereby mitigating or eliminating crosstalk phenomenon. Furthermore, the support will not block light in the transmitting zones of the display panel to pass through the liquid crystal lenses, which can further reduce or avoid influence on transmittance of display panel by the support.

An embodiment of the present invention further provides a method for manufacturing the liquid crystal lens as illustrated in FIG. 7, which can include the following steps.

S901, providing the first substrate as well as the second substrate that is configured to be disposed on light outgoing side of the display panel.

S902, forming the first part of the support on the first substrate through a patterning process.

For example, in step S902, the first part 1301 of the support 130 is formed by coating photoresist spacer material coated for the first time and through one patterning process, and then the first part 1301 of the support 130 is precured. The first part 1301 of the support 130 formed in step S902 is a photoresist spacer produced by conventional mass production processes with a height of 5 μm or so.

S903, forming the second part of the support on the first part of the support through a patterning process.

For example, in step S903, the second part 1302 of the support 130 is formed by coating photoresist spacer material for the second time and through a patterning process. The second part 1302 of the support 130 formed in step S903 is a photoresist spacer produced by conventional mass production processes with a height of 5 μm or so. The first part of the support and the second part of the support constitutes the support.

S904, cell-assembling the first substrate and the second substrate and filling liquid crystal.

The support is opposite to a non-light-outgoing area on the display panel in the light outgoing direction of the display panel.

In the liquid crystal lens light splitting device manufactured by the method according to the embodiment of the present invention, the support between the first substrate and second substrate is opposite to a non-light-outgoing area on the display panel in the light outgoing direction of the display panel, and will not impact the orientation sequence of liquid crystal molecules corresponding to a light transmitting zone of the display panel between the first substrate and second substrate, thereby mitigating or eliminating crosstalk phenomenon. Furthermore, the support will not block light in the transmitting zone of the display panel to pass the liquid crystal lenses, which can further reduce or avoid influence on transmittance of display panel by the support. Forming the first and second parts of the support through two patterning processes allows them to be manufactured completely with common manufacturing processes, which reduces the production complexity.

An embodiment of the present invention further provides a method for manufacturing the liquid crystal lens as illustrated in FIG. 8, which can include the following steps.

S1001, providing the first substrate as well as the second substrate that is configured to be disposed on light outgoing side of the display panel.

In S1002, forming the second part of the support on the second substrate through a patterning process.

For example, in step S1002, the second part 1302 of the support 130 is formed by coating photoresist spacer material for the first time and through one patterning process and then the second part 1302 of the support 130 is precured. The second part 1302 of the support 130 formed in step S1002 is photoresist spacers produced by conventional mass production processes with a height of 5 μm or so.

S1003, forming the first part of the support on the second part of the support through a patterning process.

For example, in step S1003, the first part 1301 of the support 130 is formed by coating photoresist spacer material for the second time and through a patterning process. The first part 1301 of the support 130 formed in step S1003 is a photoresist spacer produced by conventional mass production processes with a height of 5 μm or so. The first part of the support and the second part of the support constitute the support.

S1004, cell-assembling the first substrate and the second substrate and filling liquid crystal.

The support is opposite to a non-light-outgoing area on the display panel in the light outgoing direction of the display panel.

In the liquid crystal lens light splitting device manufactured by the method according to the embodiment of the present invention, the support between the first substrate and second substrate is opposite to a non-light-outgoing area on the display panel in the light outgoing direction of the display panel, and will not impact the orientation sequence of liquid crystal molecules corresponding to the light transmitting zone of the display panel between the first substrate and second substrate, thereby mitigating or eliminating crosstalk phenomenon. Furthermore, the support will not block light in the transmitting zone of the display panel to pass through the liquid crystal lenses, which can further reduce or avoid influence on transmittance of display panel by the support. Furthermore, the support consists of the first and second parts formed through two patterning processes and can be manufactured completely with common manufacturing processes, which reduces the production complexity.

An embodiment of the present invention further provides a method for manufacturing the liquid crystal lens as illustrated in FIG. 9, which can include the following steps.

S1101, providing the first substrate as well as the second substrate that is configured to be disposed on a light outgoing side of the display panel.

S1102, forming the first part of the support on the first substrate through a patterning process.

The first part 1301 of the support 130 can be formed by coating a photoresist spacer material used in conventional mass production processes on the first substrate and through a patterning process, with a height of 5 μm or so on.

S1103, the second part of the support is formed on the second substrate through a patterning process.

The second part 1302 of the support 130 can be formed by coating a photoresist spacer material used in conventional mass production processes on the second substrate and through a patterning process. The second part is disposed at a location corresponding to the first part on the first substrate and has a height of 5 μm or so on. The Support is opposite to a non-light-outgoing area on the display panel in the light outgoing direction of the display panel.

The order of the steps S1102 and S1103 are not limited in the above-mentioned process flow.

S1104, cell-assembling the first substrate and the second substrate and filling liquid crystal.

After cell-assembling, the first part 1301 of the support 130 formed in step S1202 and the second part 1302 of the support 130 formed in step S1203 together constitute the support 130 to support the cell thickness of the liquid crystal lens light splitting device.

The Support is opposite to a non-light-outgoing area on the display panel in the light outgoing direction of the display panel.

In the liquid crystal lens light splitting device manufactured by the method according to the embodiment of the present invention, the support between the first substrate and second substrate is opposite to a non-light-outgoing area on the display panel in the light outgoing direction of the display panel, and will not impact the orientation sequence of liquid crystal molecules corresponding to the light transmitting zone of the display panel between the first substrate and second substrate, thereby mitigating or eliminating crosstalk phenomenon. Furthermore, the support will not block light in the transmitting zone of the display panel to pass through the liquid crystal lenses, which can further reduce or avoid influence on transmittance of display panel by the support. Forming the first and second parts of the supports through two patterning processes allows them to be manufactured completely with common manufacturing process, which reduces the production complexity.

An embodiment of the present invention provide a stereoscopic display device including a display panel and a liquid crystal lens light splitting device that is configured to be disposed on light outgoing side of the display panel which is any one of the liquid crystal lens light splitting devices according to the above-mentioned embodiments. For example, the cell thickness is maintained by the support in the liquid crystal lens light splitting device, and the support is opposite to the non-light-outgoing area on the display panel in the light outgoing direction of display panel. The stereoscopic display device can be any product or component with display function such as electronic paper, a cell phone, a watch, a slab computer, a TV set, a display, a notebook computer, a digital picture frame, or a navigator and so on.

In the stereoscopic display device according to the above-mentioned embodiment, the support between the first substrate and the second substrate is opposite to a non-light-outgoing area on the display panel in the light outgoing direction of the display panel, and will not impact the orientation sequence of liquid crystal molecules corresponding to the light transmitting zone of the display panel between the first substrate and second substrate, thereby mitigating or eliminating crosstalk phenomenon. Furthermore, the support will not block light in the transmitting zone of the display panel to pass through the liquid crystal lenses, which can further reduce or avoid influence on transmittance of display panel by the support.

What are described above is related to the illustrative embodiments of the disclosure only and not limitative to the scope of the disclosure; the scopes of the disclosure are defined by the accompanying claims.

The present application claims priority of China Patent application No. 201410450047.8 filed on Sep. 5, 2014, the disclosure of which is hereby entirely incorporated herein by reference.

1. A liquid crystal lens light splitting device configured to be disposed on a display panel, comprising: a first substrate and a second substrate, wherein the second substrate is configured to be disposed on a light outgoing side of the display panel; liquid crystal is filled between the first substrate and the second substrate; and a support is provided between the first substrate and the second substrate; and
the support is opposite to a non-light-outgoing area on the display panel in the light outgoing direction of the display panel.

2. The liquid crystal lens light splitting device according to claim 1, wherein the liquid crystal forms at least two liquid crystal lenses, and the support is located at a border between adjacent liquid crystal lenses of the at least two liquid crystal lenses.

3. The liquid crystal lens light splitting device according to claim 1, wherein the liquid crystal lens light splitting device comprises a plurality of supports uniformly disposed between the first substrate and the second substrate.

4. The liquid crystal lens light splitting device according to claim 1, wherein the support comprises a post support and a cross section of the support in the light outgoing direction of the display panel is a circle or a polygon.

5. The liquid crystal lens light splitting device according to claim 1, wherein the support comprises a photoresist spacer.

6. The liquid crystal lens light splitting device according to claim 1, wherein the support comprises a first part and a second part; one end of the first part of the support contacts the first substrate, another end of the first part of the support contacts one end of the second part of the support, and another end of the second part of the support contacts the second substrate.

7. The liquid crystal lens light splitting device according to claim 1, wherein the display panel is a liquid crystal display panel, and the non-light-outgoing area is a black matrix area.

8. A stereoscopic display device comprising a display panel and a liquid crystal lens light splitting device configured to be disposed on a light outgoing side of the display panel, wherein the liquid crystal lens light splitting device comprises: a first substrate and a second substrate, wherein the second substrate is configured to be disposed on a light outgoing side of the display panel; liquid crystal is filled between the first substrate and the second substrate; and a support is provided between the first substrate and the second substrate; and
the support is opposite to a non-light-outgoing area on the display panel in the light outgoing direction of the display panel.

9. The stereoscopic display device according to claim 8, wherein the display panel is a liquid crystal display panel or an organic light emitting diode display panel.

10. A manufacturing method of a liquid crystal lens light splitting device, comprising:
providing a first substrate as well as a second substrate that is configured to be disposed on a light outgoing side of a display panel;
forming a support on the first substrate and/or the second substrate; and
cell-assembling the first substrate and the second substrate and filling liquid crystal therebetween;
wherein the support is opposite to a non-light-outgoing area on the display panel in the light outgoing direction of the display panel.

11. The method according to claim 10, wherein forming a support on the first substrate comprises:
forming a first part of the support on the first substrate through a patterning process; and
forming a second part of the support on the first part of the support through a patterning process;
wherein the first part of the support and the second part of the support constitute the support.

12. The method according to claim 10, wherein forming a support on the second substrate comprises:
forming a second part of the support on the second substrate through a patterning process; and
forming a first part of the support on the second part of the support through a patterning process;
wherein the first part of the supports and the second parts of the supports constitute the support.

13. The method according to claim 10, wherein forming a support on the first substrate and the second substrate comprises:
forming a first part of the support on the first substrate through a patterning process; and
forming a second part of the support on the second substrate through a patterning process;
wherein the first part of the support and the second part of the support constitute the support.

14. The method according to claim 10, wherein the support is formed through one patterning process with a material having a viscosity higher than a predetermined viscosity value.

15. The liquid crystal lens light splitting device according to claim 2, wherein the liquid crystal lens light splitting device comprises a plurality of supports uniformly disposed between the first substrate and the second substrate.

16. The liquid crystal lens light splitting device according to claim 2, wherein the support comprises a post support and a cross section of the support in the light outgoing direction of the display panel is a circle or a polygon.

17. The liquid crystal lens light splitting device according to claim 3, wherein the support comprises a post support and a cross section of the support in the light outgoing direction of the display panel is a circle or a polygon.

18. The liquid crystal lens light splitting device according to claim 2, wherein the support comprises a photoresist spacer.

19. The liquid crystal lens light splitting device according to claim 3, wherein the support comprises a photoresist spacer.

20. The liquid crystal lens light splitting device according to claim 4, wherein the support comprises a photoresist spacer.
